(19) United States
(12) Patent Application Publication
(10) Pub. No.: US 2025/0335536 A1
(43) Pub. Date: Oct. 30, 2025

(54) ARTIFICIAL INTELLIGENCE ACCELERATOR HARDWARE AND OPERATING METHOD THEREOF

(71) Applicants: Samsung Electronics Co., Ltd., Suwon-si (KR); Seoul National University R&DB Foundation, Seoul (KR)

(72) Inventors: Hanwoong JUNG, Suwon-si (KR); Jae W. LEE, Seoul (KR); Seung Yul LEE, Seoul (KR); Jihoon HONG, Seoul (KR); Hyunseung LEE, Seoul (KR); SangLyul CHO, Seoul (KR)

(73) Assignees: Samsung Electronics Co., Ltd., Suwon-si (KR); Seoul National University R&DB Foundation, Seoul (KR)

(21) Appl. No.: 19/072,919

(22) Filed: Mar. 6, 2025

(30) Foreign Application Priority Data
Apr. 25, 2024 (KR) 10-2024-0055524

(51) Int. Cl. G06F 17/14

(52) U.S. Cl. CPC G06F 17/14

(57) ABSTRACT

A computing unit, a hardware accelerator including a computing unit, and a method of operating a computing unit are disclosed. The computing unit includes a first operator circuit configured to generate a matrix used for a first operation with an input chunk through a recursive operation, and a reconfigurable array configured to reconfigure a connection to an input port or an output port to perform the first operation between the matrix and the input chunk and to perform second operations, wherein the second operations are different from the first operation.

### CROSS-REFERENCE TO RELATED APPLICATIONS

This application claims the benefit under 35 USC § 119(a) of Korean Patent Application No. 10-2024-0055524, filed on Apr. 25, 2024, in the Korean Intellectual Property Office, the entire disclosure of which is incorporated herein by reference for all purposes.

### BACKGROUND

### 1. Field

The following disclosure relates to an artificial intelligence hardware accelerator and an operating method thereof.

### 2. Description of Related Art

Long context exists anywhere in a natural sequence and is widely regarded as the core to achieving human-level perception through artificial intelligence (AI). Although self-attention-based transformers have recently achieved significant success in sequence modeling, since a computational requirement secondarily increases with respect to a sequence length to process the long context, modeling for processing a long sequence may not be easy.

### SUMMARY

In one general aspect, a computing unit includes a first operator circuit configured to generate a matrix used for a first operation with an input chunk through a recursive operation, and a reconfigurable array configured to reconfigure a connection to an input port or an output port to perform the first operation between the matrix and the input chunk and to perform second operations, wherein the second operations are different from the first operation.

The first operator circuit may be further configured to store at least some elements of the matrix, and generate the matrix through the recursive operation, wherein, for the first operation, the recursive operation iteratively multiplies the at least some elements of the matrix by a scaling factor.

The first operator circuit may be further configured to perform the first operation between the at least some elements and the input chunk by transmitting the matrix to the reconfigurable array.

The first operation may include a multiplication operation between the at least some elements and the input chunk.

The matrix may include a Vandermonde matrix for obtaining a subsequent column of a column or a subsequent row of a row through a multiplication operation between the column or the row of the matrix and a specific vector.

The first operator circuit may include four multipliers and two adders, and the first operator circuit is further configured to perform a multiplication operation between two complex numbers using the four multipliers and the two adders.

The reconfigurable array may include four adders and two multipliers, and the reconfigurable array is further configured to reconfigure the connection to the input port or the output port for the first operation or the second operations by using the four adders and the two multipliers.

The computing unit may be configured to process a complex number operation among the second operations by using the first operator circuit and the reconfigurable array, and process a Fourier transform (FFT) operation among the second operations by using the reconfigurable array.

The reconfigurable array may be further configured to reconfigure the connection to the input port or the output port to support the complex number operation, the FFT operation, and a convolution operation.

The computing unit may further include a register file including a set of registers configured to store up to six complex numbers, wherein the register file is configured to store a constant used for the first operation, a median value updated over multiple cycles in a process of the first operation, at least some elements of the matrix, or a partial sum of the at least some elements of the matrix.

The computing unit may operate in at least one of a first mode for performing the first operation by the first operator circuit, a second mode for generating a compensated twiddle factors (CTFs) matrix, a third mode for performing an FFT operation through a butterfly operation on the input chunk, a fourth mode for calculating a correction value of a current output chunk based on contribution of a previous chunk calculated by multiplying a previous state vector by the matrix, a fifth mode for updating a state vector, a sixth mode for adding two real numbers and performing an add operation on a result of multiplying two other real numbers, or a seventh mode for performing a multiplication operation between another two real numbers.

The first operator circuit and the reconfigurable array may be pipelined to have matching throughputs.

The computing unit may be on a chip including a processor and a memory and the computing unit and the processor may share the memory.

In another general aspect, a hardware accelerator includes processing elements each including a respective core configured to perform an operation with input data, wherein each core includes a set of computing units, and a memory interface configured to connect a host memory to the processing elements, wherein each of the computing units includes a first operator circuit configured to generate a matrix used for a first operation with input chunks obtained by segmenting input data through a recursive operation, and a reconfigurable array configured to reconfigure a connection to an input port or an output port to perform the first operation between the matrix and the input chunks and to perform second operations, wherein the second operations are different from the first operation.

Each of the computing units may be configured to be capable of operating in: a first mode for performing the first operation by the first operator circuit, a second mode for generating a CTFs matrix, a third mode for performing an FFT operation through a butterfly operation on the input chunk, a fourth mode for calculating a correction value of a current output chunk based on contribution of a previous chunk calculated by multiplying a previous state vector by the matrix, a fifth mode for updating a state vector, a sixth mode for adding two of a set of real numbers and performing an add operation on a result of multiplying another two real numbers in the set of real numbers, and a seventh mode for performing a multiplication operation between another two real numbers.

Each of the computing units may perform a state passing process of a state space model (SSM) includes a first step for performing FFT convolution on an input chunk by a combination of the first mode, the second mode, and the third mode, a second step for generating an output chunk by performing multiplication between the matrix and a previous state vector and calculating contribution of all previous chunks for the output chunk through the fourth mode and the sixth mode, and a third step for generating a subsequent output chunk by updating the previous state vector by a combination of the first mode and the fifth mode

Each core may cause each of its computing units to independently process data of an input vector corresponding to an index by performing an operation of a global convolutional layer by an SSM-based global convolution model.

Each of the processing elements may further include: a memory including a first memory for storing an instruction and a second memory for storing data, a frontend module configured to fetch an instruction from the first memory and load the data from a memory of a host or the second memory based on the fetched instruction, a data manipulation unit (DMU) configured to load the data from the second memory through the frontend module, modify a format of the input data based on the instruction and apply the input data to the core as an input, and reformat and store an output of the core in the second memory through a writeback device, or a direct memory access (DMA) engine configured to read data by accessing a host memory according to a DMA instruction by a trigger of the frontend module.

The DMU may include a first manipulation unit configured to apply data found in the second memory to each computing unit included in the core as an input by reordering or duplicating the data, and a second manipulation unit configured to permute and reshape an output generated by the core before writing to the second memory.

In another general aspect, a method of operating a computing unit includes generating a matrix used for a first operation with an input chunk through a recursive operation, and reconfiguring a connection to an input port or an output port to perform the first operation between the matrix and the input chunk and to perform second operations, wherein the second operations are different from the first operation.

### BRIEF DESCRIPTION OF THE DRAWINGS

The above and other aspects, features, and advantages of certain embodiments of the present disclosure will be more apparent from the following detailed description, taken in conjunction with the accompanying drawings, in which:

FIG. 1 illustrates a computing unit according to one or more embodiments;

FIG. 2 illustrates a structure and an operation of a computing unit according to one or more embodiments;

FIG. 3 illustrates operation modes of a computing unit according to one or more embodiments;

FIG. 4 illustrates a hardware accelerator including computing units according to one or more embodiments;

FIG. 5 illustrates a structure and an operation of a computing system including a hardware accelerator according to one or more embodiments;

FIG. 6 illustrates a structure and an operation of a state space model (SSM) according to one or more embodiments;

FIG. 7 illustrates a process of performing a fast Fourier transform (FFT) operation by a hardware accelerator according to one or more embodiments;

FIGS. 8A to 8C illustrate a structure and an operation of a convolution block using a state passing (SP) algorithm according to one or more embodiments;

FIGS. 9A and 9D illustrate decomposition and detailed operation processes of H3 layer execution performed by a hardware accelerator according to one or more embodiments;

FIG. 10 illustrates an operation process of an SSM according to one or more embodiments; and

FIG. 11 illustrates an operating method of a computing unit according to one or more embodiments.

A computing unit, a hardware accelerator including a computing unit, and a method of operating a computing unit are disclosed. The computing unit includes a first operator circuit configured to generate a matrix used for a first operation with an input chunk through a recursive operation, and a reconfigurable array configured to reconfigure a connection to at least one of an input port and an output port to perform the first operation between the matrix and the input chunk and second operations, which are different from the first operation.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

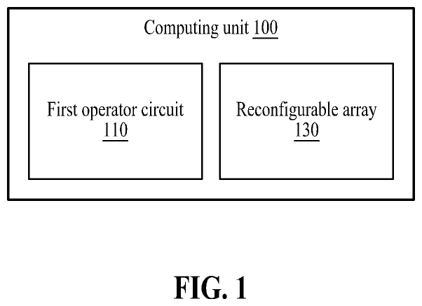

FIG. 1 illustrates a computing unit according to one or more embodiments. Referring to FIG. 1, a computing unit 100 may include a first operator circuit 110 and a reconfigurable array 130. The computing unit 100 may be, for example, a complex number compute unit (CCU), but the example is not limited thereto. Here, “complex number” refers to the mathematical class of numbers rather than complexity of a number.

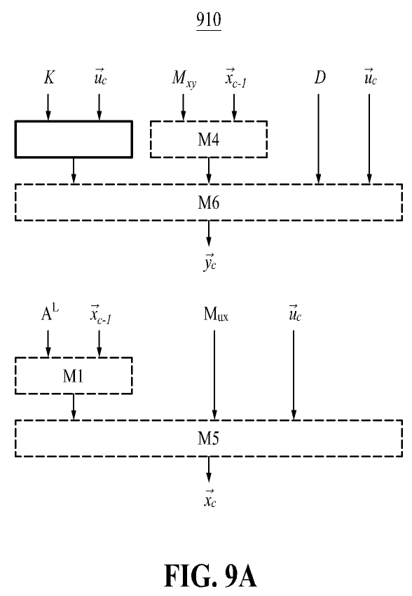

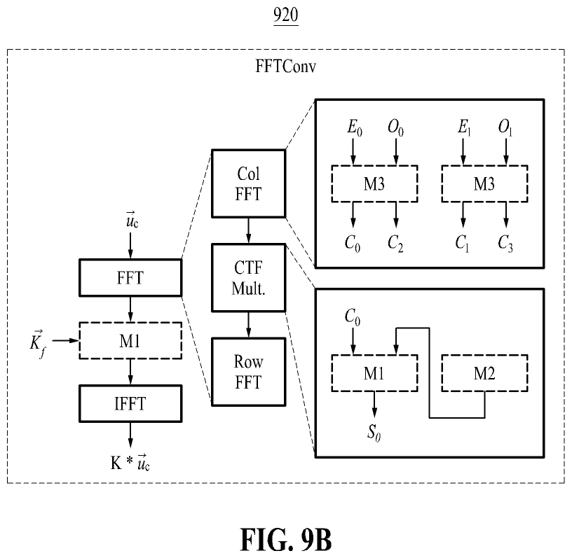

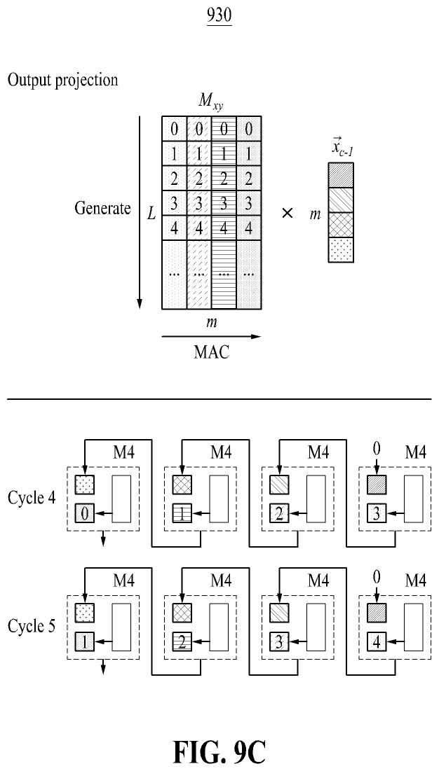

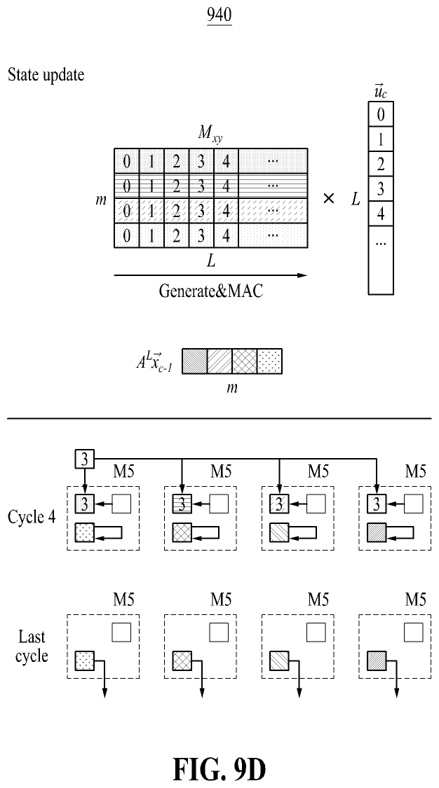

The first operator circuit 110 may generate a matrix used for a first operation with an input chunk through a recursive operation. In this case, the “chunk” may be a “representation (expression) chunk” in which closely interrelated data is gathered and may be used as a basic unit of processing. The chunk may be a portion partitioned from the entire data (the entire data may be, e.g., a long input sequence). The chunk may have a fixed size or a variable size. For example, the input chunk may be one of chunks partitioned from a long input sequence described with reference to FIG. 9A below. The chunk may be a vector. In addition, the matrix may be, for example, a Vandermonde matrix. The Vandermonde matrix may be for obtaining a following column of each column or a following row of each row through a multiplication operation of each column or each row of the matrix by a specific vector. The first operation may include a multiplication operation of at least some elements of the Vandermonde matrix by an input chunk.

The first operator circuit 110 may store the at least some elements of the matrix and may generate a matrix through a recursive operation that iteratively multiplies the at least a portion of the element by a scaling factor for the first operation. The first operator circuit 110 may store the at least some elements (e.g., some first columns and/or some rows of the Vandermonde matrices Mᵤₓ and M_{xy}) of the matrix and when an element of a matrix (Mᵤₓ and M_{xy}) is required, the first operator circuit 110 may generate a matrix through a recursive operation for iteratively multiplying the at least some elements of the matrix by a scaling factor.

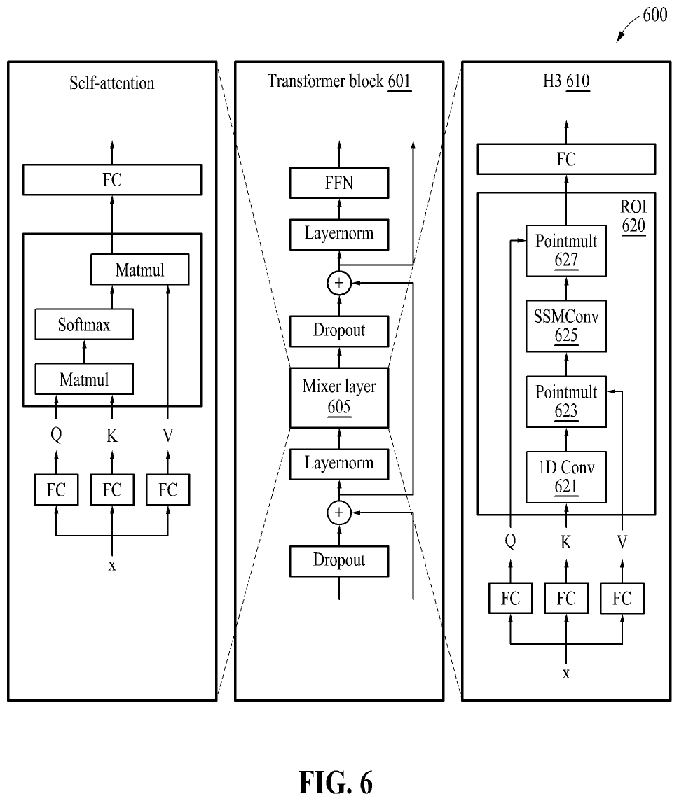

Through this, the computing unit 100 may fuse a memory-bound operation of an SSM-based global convolution (SSMConv) layer while minimizing the size of memory (e.g., SRAM). An SSM-based global convolution (SSMConv) operation is further described with reference to FIG. 6.

The first operator circuit 110 may enable a first operation between at least some elements and an input chunk by transmitting a generated matrix to the reconfigurable array 130. The first operation may be a multiplication operation but is not limited thereto.

The reconfigurable array 130 may reconfigure a connection to at least one of an input port and an output port to perform the first operation between a matrix (e.g., a Vandermonde matrix) generated by the first operator circuit 110 and an input chunk and second operations, which are different from the first operation. The second operations may include, for example, a complex number operation, a fast Fourier transform (FFT) operation, and a convolution operation. However, the example is not limited thereto.

The reconfigurable array 130 may further include a second operator circuit (not shown) configured to perform the second operations. The reconfigurable array 130 may reconfigure a connection to an input port or an output port to support a complex number operation, an FFT operation, and a convolution operation.

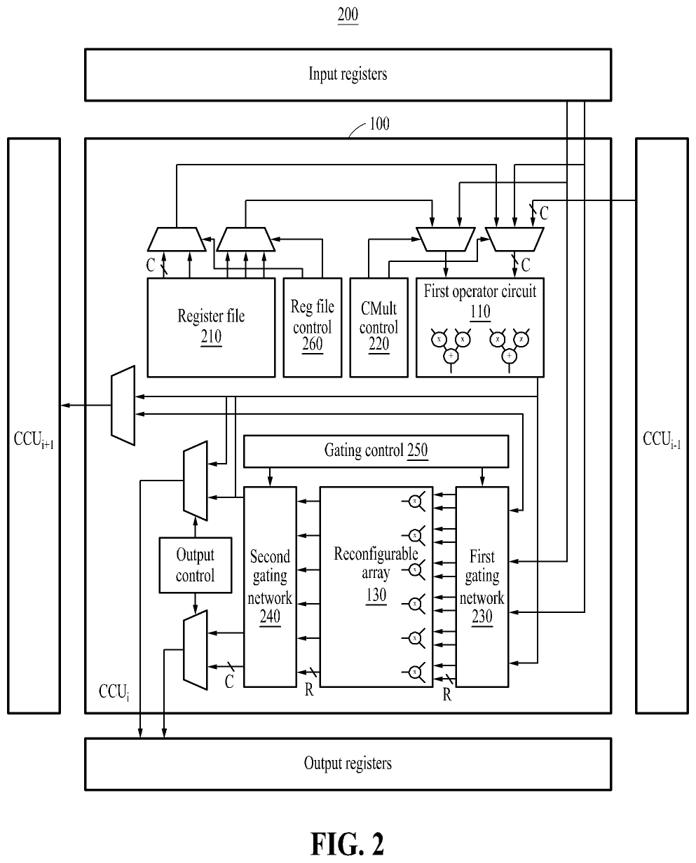

The configurations of the first operator circuit 110 and the reconfigurable array 130 are further described with reference to FIG. 2.

The computing unit 100 may process a complex number operation among the second operations by using the first operator circuit and the reconfigurable array 130 and may process an FFT operation among the second operations by using the reconfigurable array 130.

In addition, the computing unit 100 may further include a register file (e.g., refer to a register file 210 of FIG. 2) including a register set that may store up to six complex numbers. For example, the register file may store a constant used for the first operation, a median value updated over multiple cycles during the first operation, at least some elements of a matrix, or a partial sum of at least some elements of the matrix. However, the example is not limited thereto.

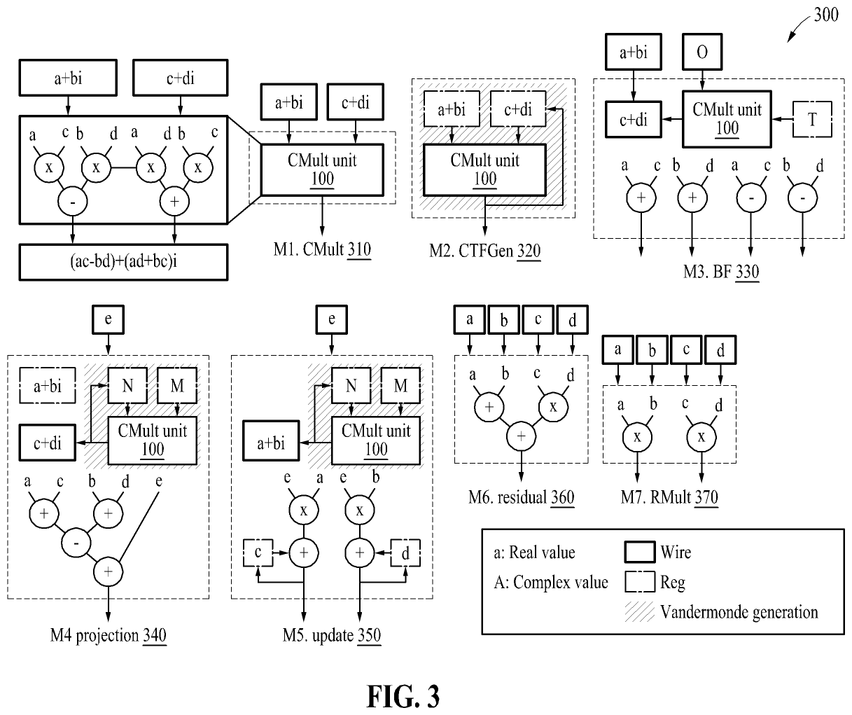

Although a detailed description is provided with reference to FIG. 3 below, briefly, the computing unit 100 may be configured operate according to multiple different operation modes. For example, the computing unit 100 may operate in a first mode M1 for performing the first operation by the first operator circuit 110, a second mode M2 for generating a compensated twiddle factors (CTFs) matrix, a third mode M3 for performing FFT through butterfly operations on an input chunk, a fourth mode M4 for calculating a correction value of a current output chunk based on a contribution of a previous chunk calculated by multiplying a previous state vector by a matrix (e.g., Mᵤₓ), a fifth mode M5 for updating a state vector, a sixth mode M6 for adding two real numbers among a set of real numbers and performing an add operation on a result obtained by multiplying two other real numbers, and a seventh mode M7 for performing a multiplication operation on another two real numbers among a plurality of real numbers.

The computing unit 100 may be on a chip including a processor and a memory, and the computing unit 100 and the processor and may share the memory (e.g., DRAM and/or SRAM).

The structure and operation of the computing unit 100 are further described with reference to FIG. 2.

FIG. 2 illustrates a structure and an operation of a computing unit according to one or more embodiments. Referring to FIG. 2, diagram 200 shows a structure of the computing unit 100 according to one or more embodiments.

The computing unit 100 may be, for example, a complex number compute unit (CCU).

The computing unit 100 may include the first operator circuit 110, the reconfigurable array 130, and a register file 210.

The first operator circuit 110 may include, for example, four multipliers and two adders and may multiply two complex numbers. The first operator circuit 110 may also be referred to as a “CMult device” since the first operator circuit 110 performs a complex number multiplication.

The first operator circuit 110 may perform a multiplication operation between two complex numbers according to a control signal of a Cmult controller 220.

The first operator circuit 110 and the reconfigurable array 130 may be pipelined together to have matching throughputs.

The reconfigurable array 130 may include, for example, four adders and two multipliers, and may provide flexible input and output ports through reconfiguration of port connections to dynamically receive demands for various operations.

A first gating network 230 may receive an input from an input register, a second gating network 240, and the first operator circuit 110, and may provide some of received inputs as inputs to operators included in the reconfigurable array 130 according to an input of a gating controller.

The second gating network 240 may receive and transmit an output of a computing unit included in the reconfigurable array 130 to, according to an input of the gating controller, either an output register, a following computing unit, or the first gating network 230.

A gating controller 250 may determine connection configuration of the first gating network 230 and the second gating network 240 according to an operation mode and timing of a set computing unit.

All multipliers and adders of the first operator circuit 110 and the reconfigurable array 130 may operate with precision of floating point (FP) 32, as a non-limiting example.

The register file 210 may include a set of registers capable of retaining up to six complex numbers. The register file 210 may store a constant used for an operation or a median value (e.g., a partial sum of an immediately generated Vandermonde matrix or an element of a Vandermonde matrix) updated over multiple cycles in an operation process. The register file 210 may transmit stored values to the first operator circuit 110 and/or the reconfigurable array 130 according to a control signal of a register file controller (reg file controller) 260.

FIG. 3 illustrates operation modes of a computing unit according to one or more embodiments. Referring to FIG. 3, diagram 300 shows seven operation modes supported by a computing unit (e.g., the computing unit 100 of FIGS. 1 and 2).

Among the seven operation modes, in a first mode Cmult 310, the computing unit may output a result (e.g., (ac-bd)+(ad+bc)i) of complex number multiplication between a+bi and c+di by receiving two complex numbers (e.g., a+bi and c+di) as an input.

In a second mode CTFGen 320, the computing unit may output a result (e.g., (ac-bd)+(ad+bc)i) of multiplying two complex numbers (e.g., a+bi and c+di) stored in the register file 210 and may replace the result of the multiplication by selecting one of the two complex numbers (e.g., c+di).

In a third mode BF 330, the computing unit may receive two complex numbers (e.g., a+bi and O) as an input and may store one (e.g., O) of the two complex numbers in the register file 210. The computing unit may output (i) a result (e.g., c+di) of multiplying a stored complex number (e.g., T) by an input O, (ii) a result (e.g., a+c, b+d) of adding the other input (e.g., a+bi), and (ii) a result of subtraction (e.g., a-c, b-d).

In a fourth mode Projection 340, the computing unit may store three complex numbers (e.g., N, M, and a+bi) in the register file 210 and may receive one real number (e.g., e). The computing unit may multiply a result (e.g., c+di) of multiplication of the complex numbers N and M by the complex number (a+bi) stored in the register file 210 and may output a value (e.g., (a+c) -(b+d)+e) obtained by adding a real part of the result to e.

In a fifth mode Update 350, the computing unit may store two complex numbers (e.g., N and M) in the register file 210 and may receive one real number (e.g., e). The computing unit may multiply a result (e.g., a+bi) of multiplication of the complex numbers N and M by the real number e and may iteratively add the multiplication result (e.g., (e×a),(e×b)) to a value (e.g., c, d) stored in the other register file of the computing unit.

In a sixth mode Residual 360, the computing unit may receive four real numbers (e.g., a, b, c, d) and may output a result obtained by adding two thereof (e.g., a, b), multiplying the other two (e.g., c, d), and adding results (e.g., (a+b), (c×d)), in other words, a result (e.g., (a+b)+(c×d)) of a residual add operation.

In a seventh mode RMult 370, the computing unit may receive four real numbers (e.g., a, b, c, d) and may output two real numbers (e.g., (a×b), (c×d)), which are values obtained by multiplying two each.

Hatched boxes indicating the second mode CTFGen 320, the fourth Projection 340, and the fifth mode Update 350 of FIG. 3 represent locations where a matrix (e.g., a Vandermonde matrix) by the first operator circuit is generated.

Each of the seven operation modes shown in FIG. 3 may define a unique connection configuration among internal components of the computing unit. All seven operation modes may be completely pipelined and may provide high throughput.

In the second mode 320, the fourth mode 340, and the fifth mode 350, the following elements of a CTF matrix, a M_{ay} matrix, and a Mᵤₓ matrix to be used may be respectively generated.

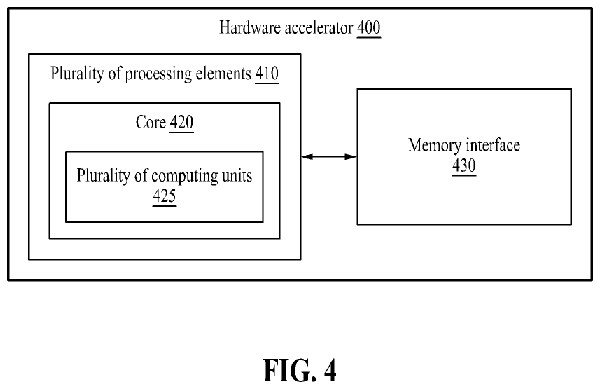

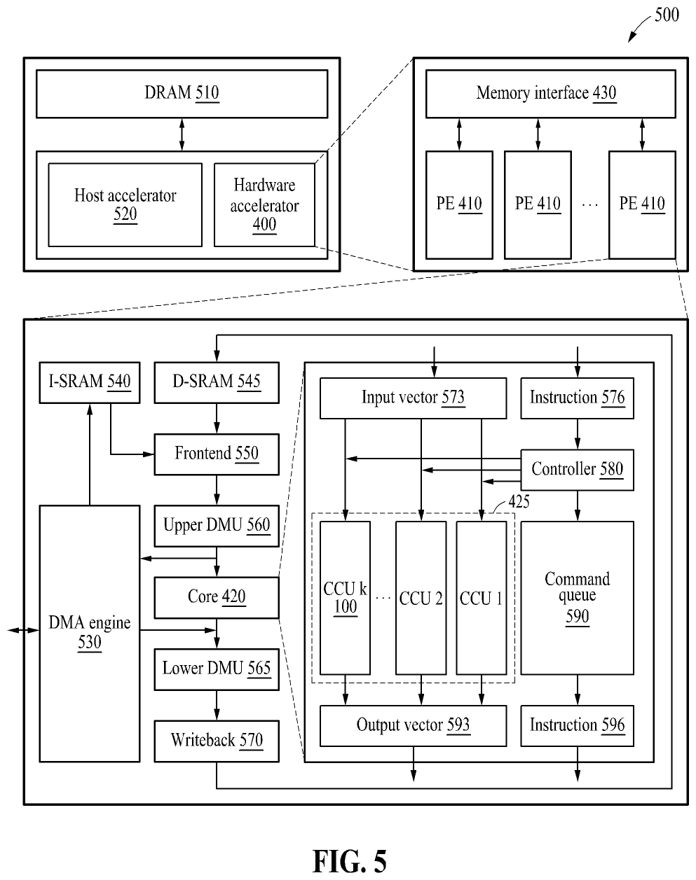

Since the computing unit independently processes an input vector in the first mode Cmult 310, the third mode BF 330, the fifth mode 350, the sixth mode Residual 360, and the seventh mode RMult 370, data flow in a core (e.g., a core 420 of FIGS. 4 and 5) may be the same as the array processor. On the other hand, in the second mode 320 and the fourth mode 340, multiple computing units may need to communicate with each other to generate a final output.

A process of performing an operation of layers (e.g., “H3 layer(s)”) of an H3 model using each mode of the computing unit is further described with reference to FIGS. 9A to 9D.

FIG. 4 illustrates a hardware accelerator including computing units according to one or more embodiments. Referring to FIG. 4, a hardware accelerator 400 according to an embodiment may include multiple processing elements (PEs) 410 and a memory interface 430.

Each of the PEs 410 may include a core 420 configured to perform an operation with input data.

The core 420 may cause each of computing units 425 to independently process data of an input vector corresponding to an index by performing an operation of a global convolutional layer by an SSM-based global convolution model.

The core 420 may include the computing units 425. Each of the computing units 425 may correspond to the computing unit 100 described above and may include a first operator circuit and a reconfigurable array. The first operator circuit may generate a matrix used for a first operation with input chunks obtained by segmenting input data through a recursive operation. In addition, the reconfigurable array may reconfigure a connection to at least one of an input port and an output port to perform the first operation between a matrix and input chunks and second operations, which are different from the first operation. Each of the computing units 425 may operate in any of the seven operation modes described above. The structure and operation of the hardware accelerator 400 are further described with reference to FIG. 5 below.

FIG. 5 illustrates a structure and an operation of a computing system including a hardware accelerator according to one or more embodiments. Referring to FIG. 5, a configuration of a computing system 500 according to an embodiment is illustrated.

The hardware accelerator 400 may be disposed adjacent to a computing device that includes a host memory (e.g., DRAM) 510 and a host accelerator 520. The host accelerator 520 may include, for example, a graphics processing unit (GPU) and/or a tensor processing unit (TPU) but is not limited thereto.

The hardware accelerator 400 may be disposed on the same die as the host accelerator 520. The hardware accelerator 400 may be used as an auxiliary processor operating with the host accelerator 520. When performing an inference process of a neural network model, an operation of a global convolutional layer may be delegated to the hardware accelerator 400 from the host accelerator 520. The hardware accelerator 400 may perform an operation of a global convolutional layer.

The hardware accelerator 400 may perform, for example, an SSM-based global convolution (SSMConv) operation by a normalized Cooley-Tukey algorithm for an FFT operation and a state passing algorithm expressed in Equation 3 described below.

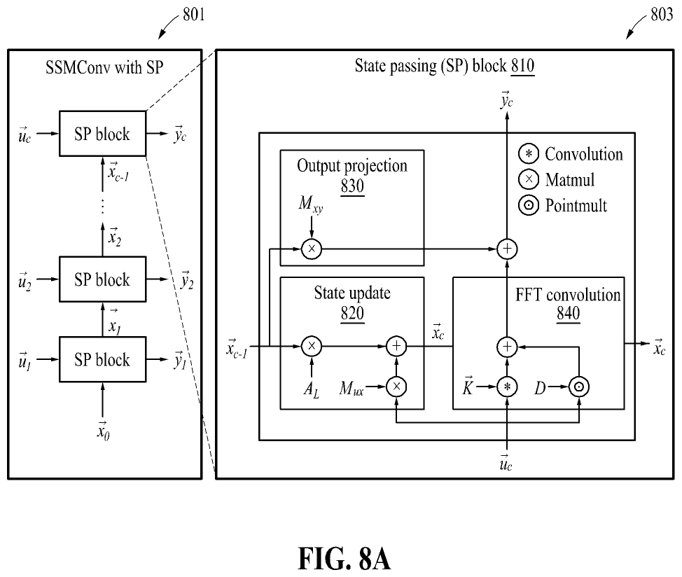

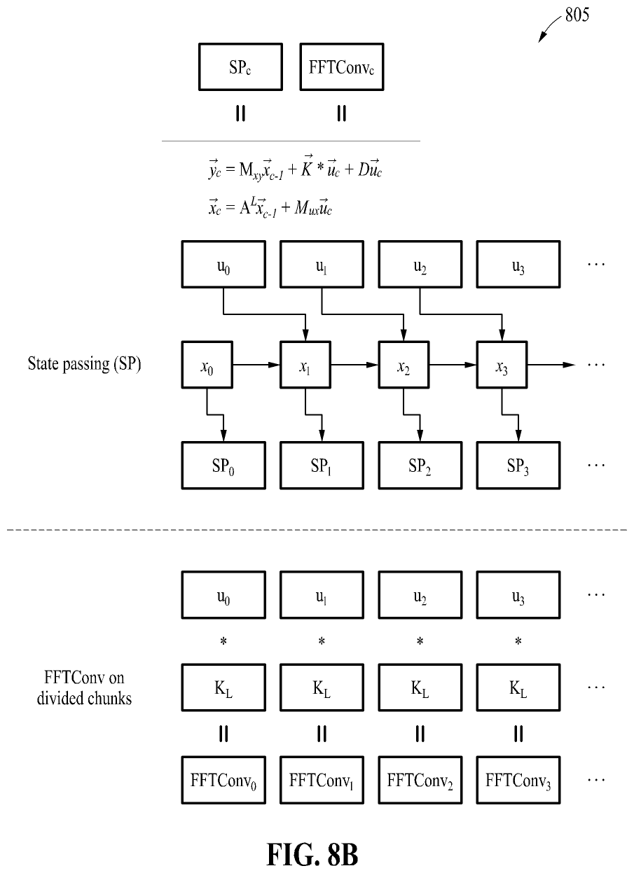

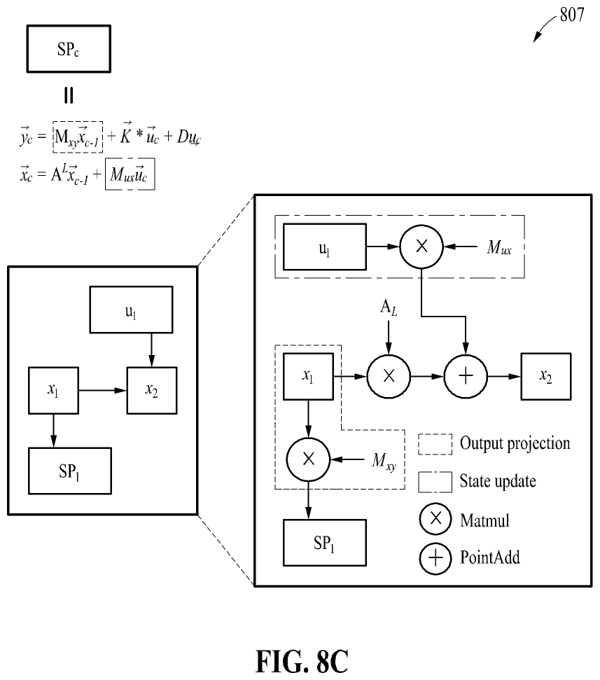

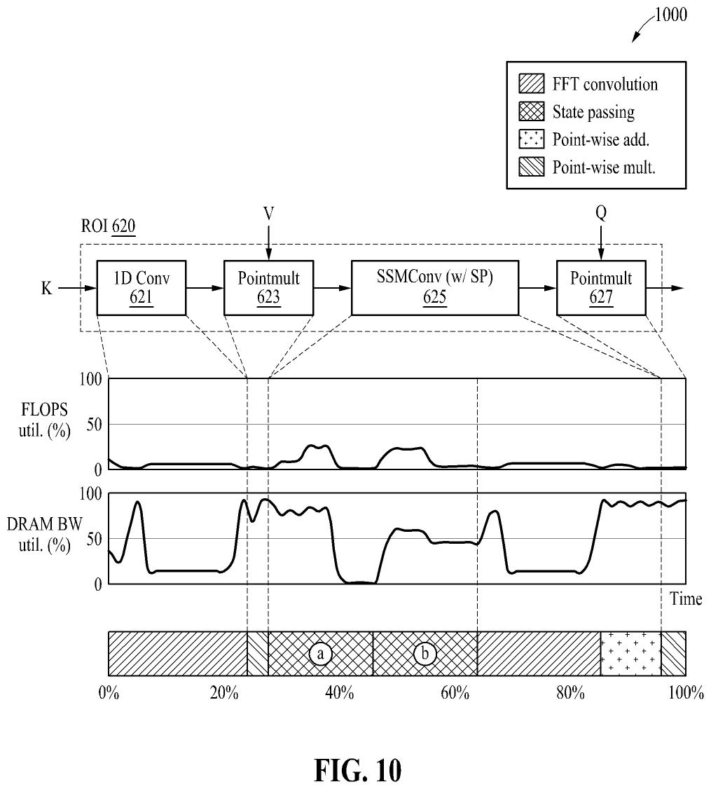

The structure and operation of the SSM are further described with reference to FIG. 6 and an operation process of the SSM is further described with reference to FIGS. 9 and 10. In addition, the structure and operation of a convolution block using a state passing (SP) algorithm are further described with reference to FIGS. 8A to 8C.

A general execution flow of the PEs 410 in the hardware accelerator 400 may begin from a frontend circuit 550, which is configured to fetch and issue an instruction. Thereafter, the hardware accelerator 400 may load data from a second memory D-SRAM 545 to a first manipulation unit (an upper data manipulation unit (DMU)) 560 and may modify a format of data as specified in the command (fetched instruction). The hardware accelerator 400 may provide the data with a modified format to the core 420 as an input.

An output of the core 420 may be appropriately formatted by a second manipulation unit (a lower DMU) 565 and may then be stored in a second memory D-SRAM 545 by a writeback device 570.

The hardware accelerator 400 may include a set of the of PEs 410. The PEs 410 may be connected to the computing system 500 via the memory interface 430.

Each of the plurality of PEs 410 may include a direct memory access (DMA) engine 530, memories 540 and 545, the frontend circuit 550, the DMUs 560 and 565, the writeback device 570, and the core 420.

The core 420 and the plurality of computing units 425 may correspond to components for an operation. The core 420 may perform all operations performed by the hardware accelerator 400.

For example, the core 420 may be built on a 1D array configured as an instance on k identical computing units among components, such as a controller and an instruction queue.

The core 420 may mainly function as an array processor in which each computing unit independently processes data of an input vector corresponding to an index. However, when multiple computing units need to communicate to generate a single value, the data may be transmitted through a one-way connection from a rightmost computing unit to a leftmost computing unit, similar to a 1D systolic array. The computing units 425 may be a basic execution element in which an actual operation occurs and may refer to the above descriptions of FIGS. 1 and 2.

Each processing element 410 may include, for example, an instance of the DMA engine 530 having an I/O width of 64B. The DMA engine 530 may access a host memory (e.g., the DRAM 510) and may read data according to a DMA instruction by a trigger of the frontend circuit 550. In the DMA instruction/command, an offset of a basic address required for a memory task may be included and the basic address may be stored in the DMA engine 530.

Since both the DMA engine 530 and the core 420 depend on the first manipulation unit (upper DMU) 560 or the second manipulation unit (lower DMU) 565 to access the second memory D-SRAM 545, the DMA engine 530 and the core 420 may compete for the hardware devices (e.g., the first manipulation unit (upper DMU) 560 and/or the second manipulation unit (lower DMU) 565). However, there may be computational phases in which either of the first manipulation unit (upper DMU) 560 or the second manipulation unit (lower DMU) 565 is not actively used by the core 420. The hardware accelerator 400 may overlap the operation and memory access by performing a DMA task in the computational phase that is not actively used by the core 420.

When the DMA task expands beyond the phase described above, the frontend circuit 550 may transmit a signal to empty the data manipulation units 560 and 565 by pausing the DMA engine 530 before the phase is terminated. After the overlapped phase, since the frontend circuit 550 immediately starts the remaining I/O task instead of performing the following command of the first memory I-SRAM 540, the access time of the memory may be delayed.

The memories 540 and 545 may include the first memory (e.g., I-SRAM) 540 and the second memory (e.g., D-SRAM) 545. The first memory (e.g., I-SRAM) 540 may be a memory for storing a command. The second memory (e.g., D-SRAM) 545 may be a memory for storing data.

The frontend circuit 550 may fetch commands from the first memory 540. The frontend circuit 550 may load input data from the memory (e.g., DRAM) of the host or the second memory (D-SRAM) 545 based on the fetched commands.

The frontend circuit 550 may include an issue logic configured to fetch and issue a command and a data logic configured to load input data from DRAM or SRAM based on an issued command. Since the same task is often iteratively performed on different pieces of data during the operation process, the hardware accelerator 400 may include a special loop instruction to specify the number of times of issuing the current command and may also include a method of updating metadata of a command over time. The issue logic may manage the loop instruction described above using multiple counters and registers. The data logic may determine row and column addresses of the second memory (D-SRAM) 545 to be accessed according to the metadata included in the command. The generation of the column address may have the form of a bit vector derived from the number of columns specified in the metadata and a starting index. In addition, the generation of the row address corresponding to each selected column may support a more complex pattern, such as a diagonal or striped pattern, across the entire range of row indices, and all of the complex patterns may be specified by the metadata.

The writeback device 570 may correspond to a write variant of a data logic of the frontend circuit 550 that supports various access pattern sets.

As shown in FIG. 5, each PE 410 in the hardware accelerator 400 may include a DMU including an instance of the first manipulation unit (upper DMU) 560 and an instance of the second manipulation unit (lower DMU) 565.

The DMUs 560 and 565 may load data from the second memory (D-SRAM) 545 through the frontend circuit 550. The DMUs 560 and 565 may modify the format of data according to the command and may apply the formatted data to the core 420 as an input. The DMUs 560 and 565 may receive an output of the core 420 and reformat the output and store it in the second memory 545 through the writeback device 570.

The DMUs 560 and 565 may each include, for example, a shifter configured to execute a predefined permutation set for bit inverse conversion, broadcast, and reduction used for a control network and FFT/inverse FFT (IFFT).

The DMUs 560 and 565 may include the first manipulation unit (upper DMU) 560 and the second manipulation unit (lower DMU) 565. The first manipulation unit 560 may allow each computing unit 100 included in the core 420 to receive a correct input by reordering or duplicating data found in the second memory 545. The second manipulation unit 565 may permute and reshape an output generated by the core 420 before writing the output to the second memory.

A storage location in the second memory (D-SRAM) 545 in which data is stored through the first manipulation unit (upper DMU) 560 and the second manipulation unit (lower DMU) 565 may not be fixed and may be flexibly changed by the order or format of an output generated by the core 420 or a required input. Through this, in an embodiment, an address of an on-chip memory may be more flexibly specified.

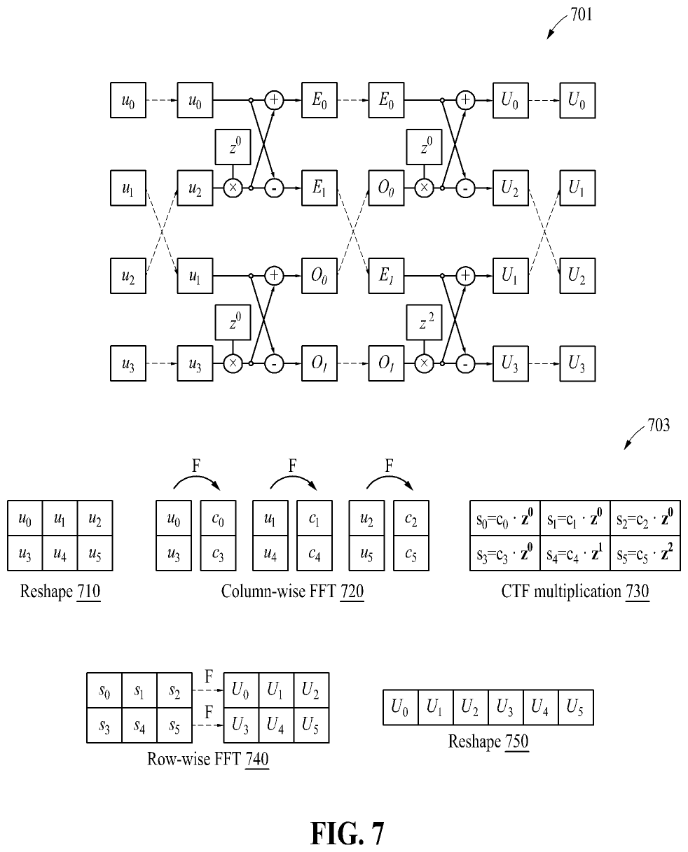

The hardware accelerator 400 may rapidly and efficiently perform an FFT operation by a combination of the DMUs 560 and 565 described above and wide SRAM I/O. The process of performing an FFT operation by the hardware accelerator 400 is further described with reference to FIG. 7.

For example, the hardware accelerator 400 may operate by executing a 16-byte command. Such a command 576 may be of two types; a configuration command and an execution command. The configuration command may set a translation lookaside buffer (TLB) corresponding to a cache of a page table and an address required for a DMA task and may change the global state of the computing unit 100. The execution command may explain/describe an execution path from the frontend circuit 550 to the writeback device 570 and also specify/control a task or mode of each module during the execution of the command. The execution path may be represented as a bit vector of a hardware module and in a configuration instruction, information, such as a read/write access pattern on the second memory (D-SRAM) 545, a permutation performed by a DMU (e.g., the second manipulation unit 565), and an operation mode of the computing unit 100, may be included. Each of the aforementioned two types of instructions may not include data (e.g., a parameter to be operated on).

All instructions fetched and issued from the frontend circuit 550 may reach the core 420 by passing through the first manipulation unit (upper DMU) 560. When a controller 580 of the core 420 receives the instruction 576, the controller 580 may perform a desired operation on an input vector 573 by setting a mode of each computing unit 100 (CCU 1 to CCU k). Only when a command requires an output (e.g., an output vector 593) generated by the core 420 to be recorded in the second memory (D-SRAM) 545 again, the command may be added to a command queue 590 in the core 420. When a valid operation output is generated by each of the computing units 100, the core 420 may transmit a signal to remove the command (e.g., the command to record a generated output) from the command queue 590 by setting a valid bit of the output vector 593. Thereafter, a command 596 may be transmitted to the second manipulation unit (lower DMU) 565 configured to perform a permutation required for the output vector 593 before the writeback device 570 writes on the second memory D-SRAM 545.

For example, a global convolution operation of an H3 model may be segmented across a hidden dimension h. In this way, since an operation of each hidden dimension is independent and is written on a memory address in which the PE 410 is not overlapped, the consistency and synchronization may not be considered. Accordingly, a consecutive part of an input sequence may be allocated to each PE 410 according to the number

$$\frac{h}{\# of PEs}$$

of h PEs 410, which are the hidden dimensions.

In addition, each PE 410 may perform global convolution with one hidden dimension on an input sequence at a time. Each PE 410 may divide a result of the global convolution into fixed-sized chunks displayed as \vec{u}c and may sequentially process chunks through state passing.

The host accelerator 520 may offload the global convolution to the hardware accelerator 400 by performing a specific initialization step of the hardware accelerator 400 before inference execution.

Firstly, the host accelerator 520 may allocate a memory area for Q, K, V, an output matrix, a command, and a state passing parameter of the SSM layer. The size of each memory area may be set to embrace all sequence lengths to a predetermined maximum value.

Thereafter, a page table entity (PTE) of each memory area may be stored in a reserved memory area to which the DMA engine 530 of the PE 410 may directly access through a physical address.

The DMA engine 530 of each PE 410 may be triggered by a memory-mapped register and a corresponding TLB may be filled with the PTE.

Since each PE 410 handles a small portion of the entire hidden dimension, only a few PTEs of the TLB may be sufficient. Based on an assumption that the maximum sequence length is 1 M, memory allocation may consume approximately 700 ms and the TLB transmission time may be ignored. Since an initialized memory area is allowed to be reused through inference, an initialization cost may be amortized. The host accelerator 520 may offload layer execution of the H3 model during inference by transmitting an input length and a layer number to the hardware accelerator 400 through a memory-mapped register. The information may be transmitted to the PE 410 and commands of the hardware accelerator 400 may be executed. Each PE 410 may transmit an operation completion signal to the host accelerator 520 through an individual completion flag register.

After the TLB in the DMA engine 530 of each PE 410 is initialized by the host accelerator 520, the DMA engine 530 may use a TLB for address conversion from a virtual memory into an actual memory. Each DMA engine 530 may retain up to 32 TLB entities for processing up to 64 MB per PE 410 when a 2 MB page is used in a GPU. When using 128 PEs 410, a total TLB reaching range may be 8 GB.

FIG. 6 illustrates a structure and an operation of a state space model (SSM) according to one or more embodiments. Referring to FIG. 6, diagram 600 shows interchangeability between a self-attention model corresponding to a mixer layer 605 of a transformer block 601 and layers of an H3 model 610.

In the H3 model 610, H3 layers may be included in the transformer block 601 instead of self-attention. A box marked with a solid line in the H3 model 610 represents a region of interest (ROI) 620, which is a target of the hardware accelerator.

The self-attention may be a powerful mechanism for dynamically capturing the relationships between inputs. A self-attention-based transformer model may achieve cutting-edge performance in a wide range of areas such as natural language processing, computer vision, and protein 3D structure prediction.

In the case of a d-dimensional input sequence having a length of I, the self-attention may transmit an input through three fully connected (FC) layers and configure query (Q), key (K), and value (V) matrices, respectively, and may obtain a (I×I) score matrix (S) by multiplying Q by K. A row of the matrix may be normalized using a softmax function. Lastly, a (I×d) matrix may be generated by multiplying S by V. However, operation and memory costs of the self-attention may secondarily increase according to the input sequence length I. Therefore, when modeling a long sequence by self-attention, the performance may be degraded.

Convolution may be widely used to effectively capture a relationship between inputs in a convolution window and may be an important component of a deep learning model, such as a convolution neural network (CNN). Instead of using a small fixed-sized filter, the global convolution model may identify a global state for the entire input using a filter of which the length and size match the length and size of the input sequence. Since the global convolution model has low quadratic computational complexity, the global convolution model may be advantageous over the self-attention when modeling long context.

Instead of a simple convolution operation having the same quadratic computational complexity as the self-attention, the global convolution model may use a well-known attribute of a convolution task corresponding to point-wise multiplication in a frequency domain. A global convolution having the complexity of O(I log I) may be efficiently implemented by applying the Fourier transform to an input sequence and a convolution filter, multiplying a result vector, and performing an inverse Fourier transform. This scheme may significantly improve the computational efficiency of a convolution process. The global convolution model may show high performance in modeling of long context even if the computational complexity is low.

In addition, various access methods may exist in the global convolution model and mainly, identifying each model may be a method of generating a filter. In an embodiment, a global convolution model based on an SSM, which is a model class used in the field of control theory or statistics, may be used to model a system that changes over time.

A convolution filter \vec{K} may be generated as Equation 1 shown below using a model of a specific class called a linear time invariant (LTI) SSM.

$$\vec{K} = ( {CA}^{0} B , {CA}^{1} B , … , {CA}^{l - 1} B ) \qquad Equation 1$$

$${y}_{i} = {CA}^{i} {\vec{x}}_{0} + {( \vec{K} * \vec{u} )}_{i} + {D}_{{\vec{u}}_{i}}$$

$$( A ∈ diag ( {ℂ}^{m} ) , B ∈ {ℂ}^{m \times 1} , C ∈ {ℂ}^{1 \times m} , D ∈ {ℂ}^{1 \times 1} )$$

In this case, an input vector \vec{u} and an output vector \vec{y} may be real number vectors having the length of I and an initial state vector \vec{x}₀ may be a complex number vector having the length of m. M may be a parameter of the SSM.

Typically, a parameter matrix A may not be diagonal, and, in this case, many matrix multiplications may be required to generate an element CAⁱB of the convolution filter \vec{K}, and thus, high kernel generation costs may be consumed and model learning may be difficult.

Accordingly, the computational burden may be reduced by limiting the matrix A to a complex diagonal matrix. The diagonalization may significantly reduce the computational complexity for computing the convolution filter \vec{K} from O(lm³) to

The H3 model 610 may correspond to a global convolution model based on the SSM described above. The H3 model 610 may be mainly configured as an H3 layer and a feed-forward network (FFN) and may have a structure similar to that of the transformer block 601; e.g., it may include an additional dropout, a residual sum, and a normalization layer.

The overall structure of H3 layer may be similar to the structure of a self-attention layer and an attention task may be replaced by global convolution. Specifically, as shown in FIG. 6, an input \vec{X} of a dimension l×d may be provided through three different FC layers and may generate three matrices (Q, K, V) having the same size. Thereafter, the H3 model 610 may perform a following operation on each column vector \vec{Q}ᵢ, \vec{K}ᵢ, \vec{V}ᵢ having the length of I.

Firstly, the H3 model 610 may perform a short 1D convolution operation 621 on the convolution filter \vec{K}ᵢ and may multiply a result thereof by \vec{V}ᵢ in a point scheme by PointMult 623. Thereafter, the H3 model 610 may perform an SSM-based global convolution (SSMConv) operation 625. The H3 model 610 may multiply \vec{Q}ᵢ in the unit of point by PointMult 627 before an SSM-based global convolution (SSMConv) operation result passes a final FC layer.

A block operation of the H3 model 610 may be divided into three areas, namely, a frontend, a global convolution operation, and a backend. The global convolution operation may occupy the largest portion of the three areas and may configure an ROI 620 for hardware acceleration.

In the ROI 620, operations, such as 1) a convolution operation using FFT convolution, point-wise multiplication, and IFFT, 2) a state passing algorithm for multiplying a state passing vector by Vandermonde matrices M_{xy} and Mᵤₓ, and 3) a point-wise operation (e.g., point-wise add and point-wise multiplication), may be performed. A ratio of each component of the ROI 620 is illustrated in FIG. 10 below.

Operations performed in the ROI 620 are as follows.

As shown in FIG. 10, FFT convolution may perform FFT, point-wise multiplication, and IFFT and may occupy the largest portion of the execution time of the ROI 620, which is approximately 45%. The FFT convolution may correspond to a core task in both a 1D convolution operation 621 and an SSMConv 625. Because state passing is used, DRAM bandwidth utilization may remain low after fetching an initial parameter from DRAM. However, since excessive memory loading and storage with frequent barrier tasks may be required before exchanging values between warps are required, computational utilization may be low.

The \textcircled{a} state update and \textcircled{b} output projection (see diamond-crosshatched areas at the bottom of FIG. 10) of the state passing algorithm may occupy approximately 36% of the ROI time. Since the reusability is limited as dimensions (m, L, C) of batch matrix multiplication are greatly distorted, the task may intensively use the memory. This attribute may be more noticeable in the batch matrix multiplication between Mᵤₓ and an input vector \vec{u} during state updating. On the other hand, a recursive operation between consecutive hidden states, which is a portion of state update, may occupy only a small portion of the entire state passing process.

However, this may only correspond to a case in which the number of input chunks is less than hundreds. When the number of chunks C significantly increases (because L is less than C or N is greater than C), the recursive operation described above may be a major bottleneck of state passing. Accordingly, it may be important to maintain L large enough to suppress the chunk C.

In the ROI 620, multiple point-wise operations may be included. In addition, as shown in FIG. 9B, since an output of output projection needs to be added to an output of FFT convolution, state passing may increase the number of point-wise operations. Since the point-wise operations are bound to the memory, it may be common to perform the point-wise operations by a single kernel into which an operator and a memory are combined. However, end-to-end fusion in layers (H3 layers) of the H3 model 610 may be limited due to the volume of shared memory required for each task.

The H3 model 610 may be characterized in two areas (an FFN/FC area and an SSM-based convolution area) having opposite computational characteristics. The former (the FFN/FC area) may be computing-intensive, and thus, may be appropriate to execute a computing-centered accelerator, such as a GPU and a TPU, and may prioritize maximum floating point operations per second (FLOPS). On the other hand, an FFT-based convolutional layer may be mostly bound to the memory and may benefit from wider and greater memory/SRAM. Since each area occupies most portions of the execution time, it may be inefficient to perform operations in two areas in a single structure.

In an embodiment, a bottleneck of each task in the ROI 620 may be resolved using an area and power-efficient SSM-based hardware accelerator (e.g., the hardware accelerator 400 of FIGS. 4 and 5) that completely offloads the ROI 620. The SSM-based hardware accelerator may accelerate FFT convolution by utilizing a sufficient SRAM bandwidth and may benefit from batched matrix multiplication due to the reduction in DRAM access.

In addition, since a large volume of SRAM is required to simply fuse all operations, the hardware accelerator may significantly reduce the required memory capacity by dynamically generating Vandermonde matrices Mᵤₓ, M_{xy}, and a CTF matrix rather than storing the entire matrix in SRAM. To achieve this, for example, the hardware accelerator may efficiently compute a butterfly operation described with reference to FIG. 7 below and it may also generate an element of a Vandermonde matrix through flexible reconfiguration of a port.

FIG. 7 illustrates a process of performing a fast Fourier transform (FFT) operation by a hardware accelerator according to one or more embodiments. Referring to FIG. 7, diagrams 701 and 703 show an operation process of a Cooley-Tukey FFT algorithm for FFT.

The diagram 701 represents a butterfly operation of a Radix-2 Cooley-Tukey FFT algorithm (hereinafter, referred to as the “Cooley-Tukey FFT algorithm”) for an input sequence having a length of 4. In this case, the “butterfly operation” may correspond to a portion of an operation that combines a result of smaller discrete Fourier transform (DFT) with greater DFT in the FFT algorithm or reversely, divides a combining operation or greater DFT into lower conversion. In this case, the term “butterfly” reflects the shape of a data flow diagram. A dotted line in the diagram 701 may represent a permutation. In addition, the diagram 703 shows an operation process of a normalized algorithm with respect to an input sequence having a length of 6.

The DFT may correspond to a process of converting a vector
\vec{u}=(u₀, u₁, . . . , u_{L-1}) in a time domain into a different length-L vector \vec{U}=(U₀, U₁, . . . , U_{L-1}) in a frequency domain. The DFT is widely used in various fields but since the computational complexity of converting the vector \vec{u} in the time domain into the vector \vec{U} in the frequency domain is O(L²), an algorithm for reducing the computational complexity to O(L log L) may be widely used.

The most widely used algorithm among them may be the Cooley-Tukey FFT algorithm used when L is a power of 2. The Cooley-Tukey FFT algorithm may correspond to a divide-and-conquer algorithm that recursively divides an input into two lower vectors having the same length.

For example, a vector \vec{u} having the length of L in a time domain may be divided into a vector consisting of an even index element \vec{e}=((u₀, u₂, . . . , u_{L-2}) and a vector consisting of an odd index element \vec{o}=(u₁, u₃, . . . , u_{L-1}). Thereafter, as two lower vectors \vec{E} and \vec{O} are generated in a DFT result, a vector \vec{U} in the frequency domain may be configured. Specifically, a relationship between two elements Uᵢ and U_{i+L/2} may be expressed as Equation 2 shown below.

$$BF ( {E}_{i} , {O}_{i} , {z}^{2 i} ) = \{ \begin{matrix}{U}_{i} = {E}_{i} + {z}^{2 i} \cdot {O}_{i} \\ {U}_{i + L / 2} = {E}_{i} - {z}^{2 i} \cdot {O}_{i}\end{matrix} \qquad Equation 2$$

In this case, (i=0,1, . . . ,L/2−1) may be satisfied.

An operation for computing Uᵢ and U_{i+L/2} from Eᵢ and Oᵢ is commonly referred as a butterfly (BF) operation. In this case, a value z may be a fixed complex number to satisfy z^{L}=1. zⁱ(i=0,1, . . . , L−1), which is a power of z, may be referred to as a twiddle factor.

In summary, the vector \vec{u} having the length of L in the time domain may have iteratively divided log₂L time and each pair (Uᵢ, U_{i+L/2}) of U may be configured through the butterfly operation.

The diagram 701 may represent an operation process when L=4.

In the diagram 701, each element of \vec{U} of a rightmost column from an input vector of a leftmost column may be obtained through two butterfly operations.

The Cooley-Tukey FFT algorithm may have a normalized version to be applied to an arbitrary number that may be expressed as a product of two natural numbers. When L is the same as (i.e., equal to) a product of L₁ and L₂, the Cooley-Tukey FFT algorithm may process \vec{u} with a 2D matrix having a dimension (L1×L2) in a row major format. The diagram 703 shows a process of performing an FFT operation by a normalized algorithm on an input sequence (L1=2 and L2=3) having the length of 6.

A hardware accelerator (e.g., the hardware accelerator 400 of FIGS. 4 and 5) may perform an FFT operation through the following five steps.
1. The hardware accelerator may reshape 710 an input vector \vec{u} is having the length of 6 into a 2×3 matrix.
2. The hardware accelerator may independently perform FFT (column-wise FFT) 720 on each column. In this case, the results of column-wise conversions may be displayed as (c0, c3), (c1, c4), and (c2, c5).
3. The hardware accelerator may perform point-wise multiplication (CTF multiplication) 730 by a CTF matrix, which is called a CTF, on a result of FFT. In this case, since the CTF has the form of a Vandermonde matrix, a computing unit of the hardware accelerator may transmit the CTF, which is a result value obtained by iteratively multiplying a starting value by a specific value, to an adjacent computing unit. The adjacent computing unit may multiply the CTF, which is a received result value, by a result of column FFT.
4. The hardware accelerator may independently perform another Fourier transform (row-wise FFT) 740 on each row.
5. The hardware accelerator may reshape 750 a result matrix into a 1D matrix corresponding to DFT of \vec{u} and may display the result matrix as \vec{U}.

Since a normalized version as the diagram 703 requires both row-wise and column-wise accesses of a 2D data matrix, an inefficient access pattern may occur.

FIGS. 8A to 8C are diagrams illustrating a structure and an operation of a convolution block using a state passing (SP) algorithm according to an embodiment.

Referring to FIG. 8A, a diagram 801 showing a process of transmitting a state vector \vec{x}_{c} from a previous SP block to a subsequent SP block in an SSM-based global convolution (SSMConv) operation process using an SP algorithm according to an embodiment and a diagram 803 showing a configuration of an SP block 810 are illustrated.

Referring to the diagram 803, an operation of the SP block 810 may include a state update process 820, an output projection process 830, and an FFT convolution and point-wise operation process 840.

A global convolution model may reduce the computational complexity of a convolution operation using an FFT algorithm. Since the FFT algorithm reads and updates the entire sequence of all steps, memory bandwidth may be an important factor in performance.

To prevent a bottleneck of a DRAM memory bandwidth, a GPU kernel optimized for the FFT algorithm may actively utilize a shared memory of an SSM according to the entire input sequence. When the input sequence extends and the entire sequence no longer fits in SRAM, an additional DRAM access may occur.

The SSM-based hardware accelerator may divide an input sequence \vec{u} having the length of N(=C×L) into C chunk vectors \vec{u}_{c}(c=0, 1, . . . , C-1) having the length of L as the diagrams 801 and 805, and thereby, may block an occurrence of additional DRAM access occurring when the input sequence extends. A convolution operation using the FFT algorithm may be individually performed in each chunk with the assistance of an SP algorithm. The SP algorithm may correspond to a method of adding an influence of a previous chunk to a current chunk. According to the SP algorithm, the hardware accelerator may obtain a value to be added to the current chunk by multiplying a previous state vector by a Vandermonde matrix M_{xy}. The hardware accelerator may generate a state vector to be used in a subsequent chunk by adding a scaled previous state vector

$${A}_{{\vec{x}}_{c - 1}}^{L}$$

to a result obtained by multiplying the Vandermonde matrix Mᵤₓ by the current chunk.

Since a chunk size may be freely selected according to the GPU SRAM capacity, this mechanism may significantly reduce memory access to DRAM during the FFT operation. This may be possible since an element of a convolution filter \vec{K}ᵢ has a recursive relationship. All previous chunks may be summarized as a previous-state vector \vec{x}_{c-1} and the contribution of the previous chunk may be separately computed from convolution of the current chunk.

The state passing may be performed through the following two steps.
1) The hardware accelerator may update a previous state vector \vec{x}_{c-1} to a state vector \vec{x}_{c} using a chunk vector \vec{u}_{c} (state update).
2) The hardware accelerator may generate an output chunk \vec{y}_{c} by adding an FFT-based convolution output (FFT convolution) of a corresponding input chunk \vec{u}_{c} to projection of the previous state vector \vec{x}_{c-1}.

In Equation 3 below, two equations for the state vector \vec{x}_{c} and the output chunk \vec{y}_{c} may represent operations related to each process (e.g., a state update process 820, an output projection process 830, and an FFT convolution and point-wise operation process 840) shown in the diagrams 803 and 807.

$$\vec{K} = ( {CA}^{0} B , {CA}^{1} B , … , {CA}^{L - 1} B ) \qquad Equation 3$$

$${\vec{x}}_{c} = {A}_{{\vec{x}}_{c - 1}}^{L} + {M}_{ux} {\vec{u}}_{c}$$

$${\vec{y}}_{c} = {M}_{xy} {\vec{x}}_{c - 1} + \vec{K} * {\vec{u}}_{c} + D {\vec{u}}_{c}$$

In this case, matrices M_{xy} and Mᵤₓ used in Equation 3 may be expressed as Equation 4 shown below.

$${M}_{xy} = ( \begin{matrix}{C}_{0} & {C}_{1} & … & {C}_{m - 1} \\ {C}_{0} {A}_{0} & {C}_{1} {A}_{1} & … & {C}_{m - 1} {A}_{m - 1} \\ ⋮ & ⋮ & ⋱ & ⋮ \\ {C}_{0} {A}_{0}^{L - 1} & {C}_{1} {A}_{1}^{L - 1} & … & {C}_{m - 1} {A}_{m - 1}^{L - 1}\end{matrix} ) \qquad Equation 4$$

$${M}_{ux} = ( \begin{matrix}{A}_{0}^{L - 1} {B}_{0} & … & {A}_{0} {B}_{0} & {B}_{0} \\ {A}_{1}^{L - 1} {B}_{1} & … & {A}_{1} {B}_{1} & {B}_{1} \\ ⋮ & ⋱ & ⋮ & ⋮ \\ {A}_{m - 1}^{L - 1} {B}_{m - 1} & … & {A}_{m - 1} {B}_{m - 1} & {B}_{m - 1}\end{matrix} )$$

M_{xy} and Mᵤₓ may be Vandermonde matrices including parameters A, B, and C shown in Equations 3 and 4. This may denote that all rows of M_{xy} may be obtained by recursively multiplying a first row by a fixed vector consisting of a diagonal element of A. Similarly, all columns of Mᵤₓ may be computed by multiplying a first column by the same fixed vector. This attribute may occur in the iterative nature of an SSM.

FIGS. 9A and 9D illustrate decomposition and detailed operation processes of H3 layer execution performed by a hardware accelerator, according to one or more embodiments.

Referring to FIG. 9A, diagram 910 shows a state passing process of an SSM is divided into three steps, which are convolution for FFT (FFTConv), output projection, and state update. FIG. 9A shows a formula of the state passing process as each mode.

Although a detailed description is provided below, briefly, an SSM-based neural network model (a hardware accelerator) may, for example, segment an input sequence. having the length of N(=C×L) into C input chunks \vec{u}_{c}(c=0,1, . . . , C -1) of a vector having the length of L. In this case, convolution using FFT (FFTConv) may be individually performed on each input chunk with the assistance of an SP algorithm.

In this case, for example, since the size of the input chunk \vec{u}_{c} may be freely selected according to the GPU SRAM capacity, DRAM memory access may be significantly reduced during FFT through the segmentation. This may be possible because an element of a filter \vec{K} has a recursive relationship. All previous input chunks \vec{u}_{c} may be summarized as a previous state vector \vec{x}_{c-1} and corresponding contribution may be separately computed from the convolution of a current input chunk \vec{u}_{c}.

More specifically, the hardware accelerator may calculate a value \vec{K}*\vec{u}_{c} obtained by proceeding with convolution using FFT (FFTConv) by receiving a convolution filter K and an input chunk \vec{u}_{c} in Equation 3, which is a process of generating an actual output. In addition, the hardware accelerator may calculate a value M_{xy}\vec{x}_{c-1}, which is a product of a Vandermonde matrix M_{xy} and the previous state vector \vec{x}_{c-1} by the fourth mode M4. The hardware accelerator may generate an output chunk \vec{y}_{c} by aggregating D\vec{u}_{c}, which is a value obtained by scaling the input chunk \vec{u}_{c} by D by the sixth mode M6, \vec{K}*\vec{u}_{c} and M_{xy}\vec{x}_{c-1}

In addition, the hardware accelerator may calculate

$${A}_{{\vec{x}}_{c - 1}}^{L} ,$$

which is a value obtained by scaling the previous state vector \vec{x}_{c-1} by A^{L} by the first mode M1, and may generate the state vector \vec{x}_{c} by adding the corresponding value

$${A}_{{\vec{x}}_{c - 1}}^{L}$$

to Mᵤₓ\vec{u}_{c}, which is obtained by multiplying the Vandermonde matrix Mᵤₓ by the input chunk \vec{u}_{c}, by the fifth mode M5.

In the state update process, the hardware accelerator may generate a subsequent output chunk by updating the previous state vector \vec{x}_{c-1}. The hardware accelerator may generate the subsequent output chunk by updating the previous state vector \vec{x}_{c-1} by a combination of the first mode and the fifth mode. The hardware accelerator may update the previous state vector \vec{x}_{c-1} to a state vector \vec{x}_{c} using the first mode and the fifth mode of the computing unit. In the first mode, the computing unit may compute

$${A}_{{\vec{x}}_{c - 1}}^{L}$$

which is to be used for an operation in the following fifth mode.

Referring to FIG. 9B, diagram 920 shows data flow during a convolution for FFT (FFTConv) operation process.

In the convolution for the FFT (FFTConv) process, the hardware accelerator may perform FFT convolution on an input chunk \vec{u}_{c}. For example, the hardware accelerator may perform FFT convolution on an input chunk by a combination of the first mode, the second mode, and the third mode.

For example, the convolution for the FFT (FFTConv) process may be used during a 1D convolution operation and an SSM convolution operation process. As shown in FIG. 9B, the convolution for the FFT (FFTConv) process may be performed as a combination of the first mode for performing complex multiplication (Cmult) of the first mode, the second mode for generating a CTF, and the third mode for performing a butterfly operation. In this case, for example, a complex number compute unit (CCU) may operate in a sequence of the third mode (BF)-the first mode (Cmult) and the first mode (Cmult)-the second mode (CTFGen)-the third mode (BF) to execute FFT/IFFT described in the Cooley-Tukey algorithm. The point-wise multiplication between a filter and a converted input in a frequency domain may be performed in the first mode Cmult. In the third mode (BF), a rotation factor may be loaded to a register file before an FFT/IFFT operation begins and may be reused in the entire operation. Thereafter, the hardware accelerator may multiply Oᵢ by the loaded rotation factor z²ⁱ and may generate Oᵢ·z²ⁱ. Thereafter, an adder of the reconfigurable array 130 may perform a butterfly operation using Ei and an output of the computing unit.

More specifically, the convolution using FFT (FFTConv) may include FFT, multiplication with the filter \vec{K}_{f} converted by the first mode M1, and an IFFT process, and FFT and IFFT may be performed in the order of column-wise (col-wise) FFT/IFFT, multiplication for a CTF matrix (CTF Mult), and row-wise FFT/IFFT.

The hardware accelerator may perform a butterfly operation by the third mode M3 in the column-wise (col-wise) FFT and row-wise FFT. The hardware accelerator may iteratively perform the butterfly operation as many times as the number of stages. In a multiplication operation process (CTF Mult) for the CTF matrix, two computing units may operate as a pair. One of the two computing units may generate the CTF matrix by multiplication using a Cmult unit according to the second mode M2 and the other one may multiply the CTF matrix by a result Co of FFT according to the first mode M1.

The column-wise FFT/IFFT and row-wise FFT/IFFT may follow similar procedures and only the D-SRAM access pattern may be different. To efficiently read and write D-SRAM during an operation, the hardware accelerator may use a memory layout to avoid a bank conflict.

Accordingly, each row may be easily accessed by storing data in the row-major format of SRAM. However, in the case of column-wise FFT, reading the entire column in a single cycle may not be possible because all elements of a column are stored in a single SRAM bank, and due to this, a transpose operation, which results in an expensive I/O cost, may be performed.

To prevent data movement, each row may rotate in a circular manner based on a row index. In this case, all elements of each row and each column may be disposed in different banks. For example, when 64 elements are stored in an 8-bank SRAM, 9th to 16th elements, which are the second row, may be rotated by 1 and the 9th element may be disposed in a second bank. In this manner, all elements of the first row may be read in a single cycle by accessing D-SRAM diagonally. When a DMA engine reads data from DRAM, the row-direction rotation may be performed by a lower DMU before writing on SRAM.

To perform a multiplication operation (CTF Mult) on the CTF matrix, a computing unit having an even index in the hardware accelerator may operate in the first mode and a computing unit having an odd index may operate in the second mode.

The hardware accelerator may generate an additional CTF matrix by loading first few elements of the CTF matrix to the computing unit having the odd index and performing iterative multiplication. The generated element may be transmitted to an adjacent computing unit having the even index and may be multiplied by a streamed column-wise FFT result.

FIG. 9C, shows an output projection process, a diagram 930 showing a data flow in a process of performing a multiplication operation between a matrix M1 and a previous state vector \vec{x}_{c-1} according to the fourth mode M4.

In the output projection process, the hardware accelerator (or the computing unit) may generate an output chunk using a result of the FFT convolution process of FIG. 9B. The hardware accelerator may generate, for example, an output chunk \vec{y}_{c} by performing multiplication between the matrix M_{xy} and the previous state vector \vec{x}_{c-1} through the fourth mode M4.

In addition, the hardware accelerator may compute the contribution of all previous chunks for the output chunk \vec{y}_{c} by performing multiplication between the matrix M_{xy} and the previous state vector \vec{x}_{c-1} in the fourth mode.

The hardware accelerator may iteratively generate a single column element of the matrix M_{xy} in the fourth mode. The column index may match an index of an element of a state vector \vec{x}_{c-1} stored in a register file. The generated column element may be multiplied by an element of the state vector \vec{x}_{c-1}. In this case, a partial sum propagated from an adjacent computing unit may be added through a one-way connection.

In the fourth mode, a matrix may be generated by a column in each computing unit, whereas an accumulate operation may be performed in the manner shown in the diagram 930 since for an output element, an inner product for each row of the matrix is required.

More specifically, the hardware accelerator may generate a specific column of a Vandermonde matrix M_{xy} in each computing unit and may perform multiplication M_{xy}\vec{x}_{c-1} between the previous state vector \vec{x}_{c-1} stored in the register file and the generated specific column. The hardware accelerator may transmit M_{xy}\vec{x}_{c-1}, which is a multiplication result, to an adjacent computing unit and may cause a multiplication result of the adjacent computing unit to be added to M_{xy}\vec{x}_{c-1}. In this case, to add to the multiplication results of the same row of the computing unit, the hardware accelerator may apply an appropriate delay to each computing unit.

In addition, the hardware accelerator may insert an appropriate delay into each computing unit when starting a mode to properly synchronize an accumulate operation across the computing units.

Referring to FIG. 9D, diagram 940 shows a data flow in a process of performing a multiplication operation between a Vandermonde matrix Mᵤₓ and an input chunk \vec{u}_{c} according to the fifth mode M5 during a state update process.

In the state update process, each computing unit of the hardware accelerator may handle a row of the Vandermonde matrix Mᵤₓ according to the fifth mode M5. The hardware accelerator may perform a multiplication operation between an element of an input chunk \vec{u}_{c} broadcasted to all computing units and a row element of the generated Vandermonde matrix Mᵤₓ, and then, may store a multiplication operation result in a register file included in each computing unit. Elements of the input chunk \vec{u}_{c} in all cycles may be sequentially broadcasted to a set of computing units in the fifth mode. At the same time, each computing unit may generate an element of which a column index in a specified row of the Mᵤₓ matrix matches a row index of the broadcasted element. Thereafter, the generated element may be multiplied by the broadcasted element. In this case, since a generation direction is the same as a direction of a multiplication and accumulation (MAC) operation, a partial sum may be accumulated in a register in each computing unit without the need for communication with other computing units.

The register file may be initialized as an element of

$${A}_{{\vec{x}}_{c - 1}}^{L}$$

computed before the chunk vector \vec{u}_{c} is streamed. After the entire chunk vector \vec{u}_{c} is consumed, the multiplication operation result may be read from the register file and may be recorded in memory (e.g., SRAM). In this case, since the register file may have the previous state vector

$${A}_{{\vec{x}}_{c - 1}}^{L}$$

scaled to an initial value, the multiplication operation result may be added to the scaled previous state vector

$${A}_{{\vec{x}}_{c - 1}}^{L}$$

When the accumulation of operation results of the computing units is terminated, the hardware accelerator may finally output an accumulated operation result.

In addition to the operation according to the modes of the computing unit described above, the hardware accelerator may perform a point-wise multiplication operation among an output, V, and Q. The operation may be performed in the sixth mode of the computing unit and two independent multiplication operations may be performed by four given actual input values m.

FIG. 10 illustrates an operation process of an SSM according to one or more embodiments. Referring to FIG. 10, diagram 1000 shows a result of analyzing a ratio of each component in the ROI 620 in an H3 block operation when executing a single batch.

Since the memory access is for non-reusable activation between batches, the ratio may remain similar as the batch size increases. Frontend and backend areas may include all remaining tasks, such as an FC layer of an H3 layer, a dropout and layer normalization layer, and a final FFN of an H3 block. Such tasks may be mostly compute-intensive and may be highly appropriate to execute in an existing data parallel accelerator, such as a GPU or a TPU.

In the example shown in FIG. 10, a hidden dimension h=768, a sequence length I=64K, an SSM parameter m=64, and a state passing length L=2K. FLOPS may be normalized to the theoretical maximum TF-32 FLOPS of an SM and a tensor core. \textcircled{a} and \textcircled{b} of state passing may represent state update and output projection, respectively. Since a kernel length (m=64) falls within a range suitable for FFT convolution, 1D Conv may use FFT convolution.

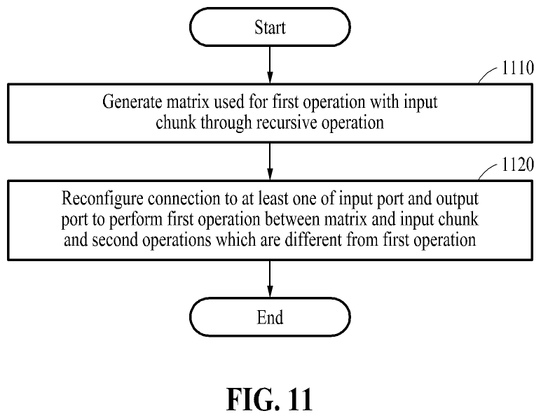

FIG. 11 illustrates an operating method of a computing unit according to one or more embodiments. Referring to FIG. 11, a computing unit may perform an operation through operations 1110 and 1120.

In operation 1110, the computing unit may generate a matrix used for a first operation with an input chunk through a recursive operation. The computing unit may store the at least some elements of the matrix in a register file and may generate a matrix through a recursive operation that iteratively multiplies the at least a portion of the element by a scaling factor for the first operation.

In operation 1120, the computing unit may reconfigure a connection to an input port or an output port to perform the first operation between the matrix generated in operation 1110 and the input chunk and second operations, which are different from the first operation.

The embodiments described herein may be implemented using a hardware component, a software component and/or a combination thereof. A processing device may be implemented using one or more general-purpose or special-purpose computers, such as, for example, a processor, a controller and an arithmetic logic unit (ALU), a DSP, a microcomputer, an FPGA, a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that may be executed by the computer using an interpreter.

The above-described devices may be configured to act as one or more software modules in order to perform the operations of the above-described examples, or vice versa.

The computing apparatuses, the electronic devices, the processors, the memories, the accelerators, the displays, the information output system and hardware, the storage devices, and other apparatuses, devices, units, modules, and components described herein with respect to FIGS. 1-11 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-11 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media.

Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A computing unit comprising:
a first operator circuit configured to generate a matrix used for a first operation with an input chunk through a recursive operation; and
a reconfigurable array configured to reconfigure a connection to an input port or an output port to perform the first operation between the matrix and the input chunk and to perform second operations, wherein the second operations are different from the first operation.

2. The computing unit of claim 1, wherein the first operator circuit is further configured to:
store at least some elements of the matrix, and
generate the matrix through the recursive operation, wherein, for the first operation, the recursive operation iteratively multiplies the at least some elements of the matrix by a scaling factor.

3. The computing unit of claim 2, wherein the first operator circuit is further configured to:
perform the first operation between the at least some elements and the input chunk by transmitting the matrix to the reconfigurable array.

4. The computing unit of claim 3, wherein the first operation comprises a multiplication operation between the at least some elements and the input chunk.

5. The computing unit of claim 1, wherein the matrix comprises a Vandermonde matrix for obtaining a subsequent column of a column or a subsequent row of a row through a multiplication operation between the column or the row of the matrix and a specific vector.

6. The computing unit of claim 1, wherein the first operator circuit comprises four multipliers and two adders, and
the first operator circuit is further configured to perform a multiplication operation between two complex numbers using the four multipliers and the two adders.

7. The computing unit of claim 1, wherein the reconfigurable array comprises four adders and two multipliers, and
the reconfigurable array is further configured to reconfigure the connection to the input port or the output port for the first operation or the second operations by using the four adders and the two multipliers.

8. The computing unit of claim 1, wherein the computing unit is configured to:
process a complex number operation among the second operations by using the first operator circuit and the reconfigurable array, and
process a Fourier transform (FT) operation among the second operations by using the reconfigurable array.

9. The computing unit of claim 8, wherein the reconfigurable array is further configured to reconfigure the connection to the input port or the output port to support the complex number operation, the FT operation, and a convolution operation.

10. The computing unit of claim 1, further comprising:
a register file comprising a set of registers configured to store up to six complex numbers,
wherein the register file is configured to store a constant used for the first operation, a median value updated over multiple cycles in a process of the first operation, at least some elements of the matrix, or a partial sum of the at least some elements of the matrix.

11. The computing unit of claim 1, wherein the computing unit operates in at least one of:
a first mode for performing the first operation by the first operator circuit;
a second mode for generating a compensated twiddle factors (CTFs) matrix;
a third mode for performing an FFT operation through a butterfly operation on the input chunk;
a fourth mode for calculating a correction value of a current output chunk based on contribution of a previous chunk calculated by multiplying a previous state vector by the matrix;
a fifth mode for updating a state vector;
a sixth mode for adding two real numbers and performing an add operation on a result of multiplying two other real numbers; or
a seventh mode for performing a multiplication operation between another two real numbers.

12. The computing unit of claim 1, wherein the first operator circuit and the reconfigurable array are pipelined to have matching throughputs.

13. The computing unit of claim 1, wherein the computing unit is on a chip comprising a processor and a memory and the computing unit and the processor share the memory.

14. A hardware accelerator comprising:
processing elements each comprising a respective core configured to perform an operation with input data, wherein each core comprises a set of computing units; and
a memory interface configured to connect a host memory to the processing elements,
wherein each of the computing units comprises:
a first operator circuit configured to generate a matrix used for a first operation with input chunks obtained by segmenting input data through a recursive operation; and
a reconfigurable array configured to reconfigure a connection to an input port or an output port to perform the first operation between the matrix and the input chunks and to perform second operations, wherein the second operations are different from the first operation.

15. The hardware accelerator of claim 14, wherein each of the computing units is configured to be capable of operating in:
a first mode for performing the first operation by the first operator circuit;
a second mode for generating a compensated twiddle factors (CTFs) matrix;
a third mode for performing a fast Fourier transform (FFT) operation through a butterfly operation on the input chunk;
a fourth mode for calculating a correction value of a current output chunk based on contribution of a previous chunk calculated by multiplying a previous state vector by the matrix;
a fifth mode for updating a state vector;
a sixth mode for adding two of a set of real numbers and performing an add operation on a result of multiplying another two real numbers in the set of real numbers; and
a seventh mode for performing a multiplication operation between another two real numbers.

16. The hardware accelerator of claim 15, wherein each of the computing units performs a state passing process of a state space model (SSM) comprising:
a first step for performing FFT convolution on an input chunk by a combination of the first mode, the second mode, and the third mode;
a second step for generating an output chunk by performing multiplication between the matrix and a previous-state vector and calculating contribution of all previous chunks for the output chunk through the fourth mode and the sixth mode; and
a third step for generating a subsequent output chunk by updating the previous-state vector by a combination of the first mode and the fifth mode.

17. The hardware accelerator of claim 14, wherein each core causes each of its computing units to independently process data of an input vector corresponding to an index by performing an operation of a global convolutional layer by an SSM-based global convolution model.

18. The hardware accelerator of claim 14, wherein each of the processing elements further comprises:
a memory comprising a first memory for storing an instruction and a second memory for storing data;
a frontend module configured to fetch an instruction from the first memory and load the data from a memory of a host or the second memory based on the fetched instruction;
a data manipulation unit (DMU) configured to load the data from the second memory through the frontend module, modify a format of the input data based on the instruction and apply the input data to the core as an input, and reformat and store an output of the core in the second memory through a writeback device; or
a direct memory access (DMA) engine configured to read data by accessing a host memory according to a DMA instruction by a trigger of the frontend module.

19. The hardware accelerator of claim 18, wherein the DMU comprises:
a first manipulation unit configured to apply data found in the second memory to each computing unit comprised in the core as an input by reordering or duplicating the data; and
a second manipulation unit configured to permute and reshape an output generated by the core before writing to the second memory.

20. A method of operating a computing unit, the method comprising:
generating a matrix used for a first operation with an input chunk through a recursive operation; and
reconfiguring a connection to an input port or an output port to perform the first operation between the matrix and the input chunk and to perform second operations, wherein the second operations are different from the first operation.
